(19) United States
(12) Patent Application Publication
(10) Pub. No.: US 2026/0128465 A1
(43) Pub. Date: May 7, 2026

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Nam Ju KIM, Suwon-si (KR); Jung Seong LEE, Suwon-si (KR); Hyeon Seon CHOI, Suwon-si (KR); Bae Wook LEE, Suwon-si (KR); Jae Yeon LEE, Suwon-si (KR); Dong Wan SEO, Suwon-si (KR)

(73) Assignee: SAMSUNG SDI CO., LTD., Yongin-si (KR)

(21) Appl. No.: 19/381,459

(22) Filed: Nov. 6, 2025

(30) Foreign Application Priority Data
Nov. 7, 2024 (KR) 10-2024-0157092

(51) Int. Cl. H01M 50/446; H01M 10/0525; H01M 50/42; H01M 50/434; H01M 50/489

(52) U.S. Cl. CPC H01M 50/446; H01M 10/0525; H01M 50/42; H01M 50/434; H01M 50/489

(57) ABSTRACT

The present disclosure relates to a separator for a rechargeable lithium battery and a rechargeable lithium battery including the separator. The separator includes a porous substrate, a first coating layer on a first surface of the porous substrate, and a second coating layer on a second surface of the porous substrate. The first coating layer and the second coating layer include a binder and a filler, the binder of the first coating layer includes a first binder, and the binder of the second coating layer includes a second binder. The first binder and the second binder each include a copolymer of a monomer mixture including a first structural unit including a unit derived from an aromatic based unsaturated monomer, a second structural unit derived from a (meth)acrylic monomer, and a third structural unit derived from a sulfonic acid group-containing monomer.

### CROSS-REFERENCE TO RELATED APPLICATION

The present application claims priority to Korean Patent Application No. 10-2024-0157092, filed on Nov. 7, 2024 in the Korean Intellectual Property Office, the entire disclosure of which is incorporated herein by reference.

### BACKGROUND

### 1. Field of the Disclosure

The present disclosure relates to a separator for a rechargeable lithium battery, and a rechargeable lithium battery including the separator.

### 2. Discussion of Related Art

With increasing presence of electronic devices using batteries, such as, e.g., mobile phones, notebook computers, electric vehicles, and the like, the demand for secondary batteries having high energy density and high capacity is increasing. Therefore, improving the performance of rechargeable lithium batteries may be advantageous.

A rechargeable lithium battery includes a positive electrode and a negative electrode that contain an active material capable of the intercalation and deintercalation of lithium ions, and produces electrical energy by oxidation and reduction reactions when the lithium ions are intercalated into and deintercalated from the positive electrode and the negative electrode.

### SUMMARY

The present disclosure is directed to providing a separator for a rechargeable lithium battery, which exhibits low membrane resistance when impregnated with an electrolyte.

The present disclosure is also directed to providing a separator for a rechargeable lithium battery, which exhibits high electrolyte wettability, desired or improved air permeability, and high adhesion to an electrode plate.

The present disclosure is also directed to providing a separator for a rechargeable lithium battery, which exhibits desired or improved heat resistance.

The present disclosure is also directed to providing a separator for a rechargeable lithium battery, which exhibits a high capacity retention rate and a low direct current internal resistance (DC-IR) change rate at room temperature and at high temperature.

The present disclosure is also directed to providing a rechargeable lithium battery including the above-described separator for a rechargeable lithium battery.

One aspect of the present disclosure includes a separator for a rechargeable lithium battery.

The separator for a rechargeable lithium battery includes a porous substrate, a first coating layer located on a first surface of the porous substrate, and a second coating layer located on a second surface of the porous substrate. The first coating layer includes a binder and a filler, and the second coating layer includes a binder and a filler. The binder of the first coating layer includes a first binder, and the binder of the second coating layer includes a second binder. The first binder and the second binder each include a copolymer including a first structural unit including a unit derived from an aromatic based unsaturated monomer, a second structural unit derived from a (meth)acrylic monomer containing an alkyl group having 4 or more carbon atoms in the main chain in the ester moiety, and a third structural unit derived from a sulfonic acid group-containing monomer. With respect to 100 mol % of the copolymer, about 5 mol % to about 80 mol % of the first structural unit, about 10 mol % to about 40 mol % of the second structural unit, and about 5 mol % to about 80 mol % of the third structural unit are included. The filler of the first coating layer includes a first filler, and the filler of the second coating layer includes a second filler, and the first filler and the second filler satisfy the following Expression 1:

$$( Average particle size ( D 50 ) of second filler ) / ( Average particle size ( D 50 ) of first filler ) \geq 3. \qquad Expression 1$$

Another aspect of the present disclosure includes a rechargeable lithium battery.

The rechargeable lithium battery includes a positive electrode, a negative electrode, and the above-described separator interposed between the positive electrode and the negative electrode.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a scanning electron microscope (SEM) image of an amorphous filler;

FIG. 2 is an SEM image of a cubic filler;

FIG. 3 is a schematic cross-sectional view of a separator for a rechargeable lithium battery according to an example embodiment; and

FIG. 4 to FIG. 7 are schematic cross-sectional views of rechargeable lithium batteries according to example embodiments.

### DETAILED DESCRIPTION

Hereinafter, example embodiments of the present disclosure are described in detail. However, the embodiments are presented as examples, the present disclosure is not limited thereto, and the present disclosure is only defined by the scope of the appended claims.

Unless otherwise stated herein, when a part such as a layer, a membrane, an area, a plate, and the like, is described as being disposed “on” another part, it includes not only a case where the part is “directly on” another part, but also a case where there are other parts present therebetween.

Unless otherwise stated herein, the singular may also include the plural. In addition, unless otherwise stated, the term “A or B” may mean “including A, including B, or including A and B.”

In the present specification, “a combination thereof” may mean a mixture, stack, composite, copolymer, alloy, blend, or reaction product of constituents.

Unless otherwise defined herein, “particle size D100” refers to a size of a particle with a cumulative volume of 100% by volume in a particle size distribution. The particle size D100 may be measured by methods known to those skilled in the art, and for example may be measured using, e.g., a particle size analyzer, a transmission electron microscope photograph, or a scanning electron microscope photograph. As another method, the particle size D100 may be obtained by measuring the particle size using a measuring device using dynamic light scattering, performing data analysis to count the number of particles for each particle size range, and then calculating the particle size D100 therefrom. Alternatively, the particle size D100 may be measured using a laser diffraction method. When measuring the particle size by the laser diffraction method, for example, the particle size D100 based on 100% of a particle size distribution in the measuring device may be calculated by dispersing particles to be measured in a dispersion medium, then introducing the dispersion medium into a commercially available laser diffraction particle size measuring device (e.g., Microtrac's MT 3000), and radiating ultrasonic waves of about 28 kHz with an output of 60 W.

Unless otherwise defined herein, “particle size D50” may be an average particle size D50, which refers to a size of a particle with a cumulative volume of 50% by volume in a particle size distribution. The particle size distribution may be obtained from the above method in the particle size D100.

If the particle is spherical, the size may refer to a diameter.

In the present specification, “(meth)acryl” refers to acryl and/or methacryl.

Hereinafter, unless otherwise defined, “substitution” means that hydrogen in a compound is substituted with a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br, or I), a hydroxy group (—OH), a nitro group (—NO₂), a cyano group (—CN), an amino group (—NRR′) (Herein, R and R′ are each independently hydrogen or a C1 to C6 alkyl group), a sulfobetaine group (—RR′N+(CH₂)ₙSO₃—, n is a natural number from 1 to 10), a carboxybetaine group (—RR′N+ (CH₂)ₙCOO—, n is a natural number from 1 to 10) (Herein, R and R′ are each independently a C1 to C20 alkyl group), an azido group (—N₃), an amidino group (—C(═NH)NH₂), a hydrazino group (—NHNH₂), a hydrazono group (═N(NH₂)), a carbamoyl group (—C(O)NH₂), a thiol group (—SH), an acyl group (—C(═O)R, Herein, R denotes hydrogen, a C1 to C6 alkyl group, a C1 to C6 alkoxy group, or a C6 to C12 aryl group), a carboxyl group (—COOH) or a salt thereof (—C(═O) OM, Herein, M denotes an organic or inorganic cation), a sulfonic acid group (—SO₃H) or a salt thereof (—SO₃M, Herein, M denotes an organic or inorganic cation), a phosphate group (—PO₃H₂) or a salt thereof (—PO₃MH or —PO₃M₂, Herein, M denotes an organic or inorganic cation), and a combination thereof.

Hereinafter, the C1 to C3 alkyl group may be or include a methyl group, an ethyl group, or a propyl group. The C1 to C10 alkylene group may be or include, for example, a C1 to C6 alkylene group, a C1 to C5 alkylene group, or a C1 to C3 alkylene group and may be or include, for example, a methylene group, an ethylene group, or a propylene group. The C3 to C20 cycloalkylene group may be or include, for example, a C3 to C10 cycloalkylene group, or a C5 to C10 cycloalkylene group, for example, a cyclohexylene group. The C6 to C20 arylene group may be or include, for example, a C6 to C10 arylene group, for example, a phenylene group. The C3 to C20 heterocyclic group may be or include, for example, a C3 to C10 heterocyclic group, for example, a pyridine group.

Hereinafter, “hetero” means including one or more heteroatoms such as or including at least one of N, O, S, Si, and P.

In addition, in the chemical formulas, the symbol * refers to a part that is connected to the same or different atom, group, or structural unit.

Unless otherwise specifically stated in the chemical formulas described herein, hydrogen may be considered to be bonded in the structure of the chemical formula.

Hereinafter, “alkali metal” refers to an element belonging to Group 1 of the periodic table, such as lithium, sodium, potassium, rubidium, cesium, or francium and may be present in a cationic or neutral state.

In the present specification, when describing a numerical range, “X to Y” means “X or more and Y or less (X≤ and ≤Y).”

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

A separator for a rechargeable lithium battery according to an example embodiment exhibits low membrane resistance when impregnated with an electrolyte. This low membrane resistance can improve the capacity and lifespan of a rechargeable lithium battery.

The separator includes a porous substrate, a first coating layer located on a first surface of the porous substrate, and a second coating layer located on a second surface of the porous substrate. The first coating layer includes a binder and a filler, and the second coating layer includes a binder and a filler, the binder of the first coating layer includes a first binder, and the binder of the second coating layer includes a second binder. The first binder and the second binder each include a copolymer including a first structural unit including a unit derived from an aromatic based unsaturated monomer, a second structural unit derived from a (meth)acrylic monomer containing an alkyl group having 4 or more carbon atoms in the main chain in the ester moiety, and a third structural unit derived from a sulfonic acid group-containing monomer. With respect to 100 mol % of the copolymer, about 5 mol % to about 80 mol % of the first structural unit, about 10 mol % to about 40 mol % of the second structural unit, and about 5 mol % to about 80 mol % of the third structural unit are included.

By including the above-described copolymer in the first coating layer and the second coating layer, the separator can provide low membrane resistance when impregnated with an electrolyte.

In an example, the separator may have a membrane resistance of about 0.7Ω or less when impregnated with an electrolyte.

The filler of the first coating layer includes a first filler, the filler of the second coating layer includes a second filler, and the first filler and the second filler satisfy the following Expression 1:

$$( Average particle size ( D 50 ) of second filler ) / ( Average particle size ( D 50 ) of first filler ) \geq 3. \qquad Expression 1$$

The separator can exhibit high electrolyte wettability, desired or improved air permeability, high heat resistance, and high adhesion to an electrode plate by including the first filler and the second filler that satisfy Expression 1. For example, Expression 1 allows the separator having the coating layer including the above-described binder to be capable of exhibiting desired or improved heat resistance and low membrane resistance. It is believed that the air permeability, electrolyte wettability, and heat resistance of the separator complement each other by disposing fillers having different average particle sizes (D50) on both sides of the porous substrate, but the present disclosure is not limited thereto. Also, when Expression 1 is satisfied, the separator can reduce or prevent membrane resistance from increasing when impregnated with an electrolyte.

In an example, when the separator is applied to a battery, the first coating layer may be laminated to a positive electrode, and the second coating layer may be laminated to a negative electrode.

In an example, a value of Expression 1, that is, a ratio of the average particle size D50 of the second filler to the average particle size D50 of the first filler may be in a range of about 3, 4, 5, 6, about 3 to about 6.

In an example, the separator may have an electrolyte wettability of about 140 wt % or more.

In an example, the separator may have an air permeability of about 150 sec/100 cc or less. In this case, air permeability refers to the time (sec) taken for 100 cc of air to pass through the unit thickness of the separator. Air permeability per unit thickness may be determined by measuring the air permeability for the total thickness of the separator, and dividing the result by the thickness. Air permeability may be determined by measuring the time (sec) taken for 100 cc of air to pass through using an air permeability measuring device (EG01-55-1MR commercially available from ASAHI SEIKO Co. Ltd.).

In an example, the separator may have an average heat shrinkage rate in the machine direction (MD) and the transverse direction (TD) of about 5% or less.

In an example, the separator may have an electrode plate adhesion of about 0.9 N or more.

The above-described membrane resistance upon impregnation with an electrolyte, electrolyte wettability, air permeability, heat resistance, and adhesion to an electrode plate may be measured by methods to be described below.

The separator may have a capacity retention rate of about 85% or more at room temperature, and a capacity retention rate of about 70% or more at high temperature. The separator may have a direct current internal resistance (DC-IR) change rate of about 220% or less after 200 cycles at room temperature, and a DC-IR change rate of about 330% or less after 200 cycles at high temperature.

Hereinafter, the separator according to an example embodiment of the present disclosure is described in further detail.

The separator includes the first coating layer and the second coating layer.

### First Coating Layer

The first coating layer includes a binder and a filler, wherein the binder includes a first binder, and the filler includes a first filler. The first filler and the first binder may be dispersed in the first coating layer.

In an example, the first binder may be included in an amount of about 95 wt % or more, for example, about 95 wt % to about 100 wt %, or about 100 wt % of the total binder in the first coating layer. In the above range, the above-described effects of the separator can be readily implemented.

In an example, the first filler may be included in an amount of about 95 wt % or more, for example, about 95 wt % to about 100 wt %, or about 100 wt % of the total filler in the first coating layer. In the above range, the above-described effects of the separator can be readily implemented.

### First Binder

The first binder may include the first structural unit, the second structural unit, and the third structural unit in a total amount of about 95 mol % or more, for example, about 95 mol % to about 100 mol %, or about 100 mol %. In the above range, the above-described effects of the separator can be readily implemented.

According to an example embodiment, the first binder may be or include a particulate binder. For example, the first binder may have an average particle size D50 in a range of about 500 nm to about 700 nm, for example 500, 510, 520, 530, 540, 550, 560, 570, 580, 590, 600, 610, 620, 630, 640, 650, 660, 670, 680, 690, 700 nm. In the above range, the adhesion of the separator can be increased.

According to an example embodiment, the first binder may constitute an adhesive binder to secure the adhesion of the separator to an electrode. There is a trade-off relationship between membrane resistance and adhesion. The copolymer may decrease the membrane resistance of the separator and increase the adhesion.

### First Structural Unit:

The first structural unit includes a unit derived from an aromatic based unsaturated monomer. The unit aromatic based unsaturated monomer may include a unit derived from an aromatic vinyl-based monomer. The unit derived from an aromatic based unsaturated monomer can provide adhesion so that the first coating layer is attached to the porous substrate and an electrode as desired, and improve the air permeability of the separator.

The unit derived from an aromatic based unsaturated monomer is represented by the following Chemical Formula 1, and the copolymer may include one or more units represented by the following Chemical Formula 1:

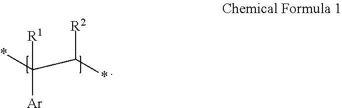

In Chemical Formula 1,
R¹ and R² each independently is or includes hydrogen or a substituted or unsubstituted C1 to C5 alkyl group, and
Ar is or includes a substituted or unsubstituted, monocyclic or polycyclic C6 to C20 aryl group).

In an example, Ar in Chemical Formula 1 is or includes a monocyclic or polycyclic C6 to C20 aryl group and may be or include, for example, a phenyl group, a naphthalenyl group, an anthracenyl group, a pyrenyl group, or the like.

In an example, the unit derived from aromatic based unsaturated monomer is represented by the following Chemical Formula 2, and the copolymer may include one or more units represented by the following Chemical Formula 2:

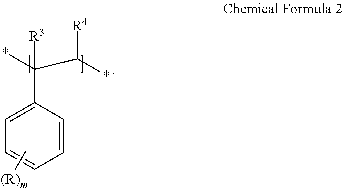

In Chemical Formula 2,
R³ and R⁴ each independently is or includes hydrogen or a substituted or unsubstituted C1 to C5 alkyl group,
R is or includes one or more of a substituted or unsubstituted C1 to C20 alkyl group, a substituted or unsubstituted C3 to C20 cycloalkyl group, a substituted or unsubstituted C1 to C20 alkoxy group, and a substituted or unsubstituted C3 to C20 aryl group, and m is an integer in a range from 0 to 5.

In an example, R in Chemical Formula 2 may be or include a substituted or unsubstituted C1 to C20 alkyl group or a substituted or unsubstituted C1 to C20 alkoxy group. In an example, m in Chemical Formula 2 may be equal to 0 or 1.

For example, the aromatic based unsaturated monomer may include one or more of styrene, α-methyl styrene, 4-butyl styrene such as 4-n-butyl styrene, 4-iso-butyl styrene, 4-t-butyl styrene, and the like, butoxy styrene including 4-butoxy styrene such as 4-n-butoxy styrene, 4-iso-butoxy styrene, 4-t-butoxy styrene, and the like, halo styrene such as chloro styrene, bromo styrene, fluoro styrene, and the like, vinyl toluene such as 4-vinyl toluene, 3-vinyl toluene, 2-vinyl toluene, and the like, and vinyl naphthalene such as 1-vinyl naphthalene, 2-vinyl naphthalene, and the like.

In addition to the unit derived from an aromatic based unsaturated monomer, the first structural unit may further include a unit derived from a (meth)acrylic monomer containing an alkyl group having about 1 to 3 carbon atoms in the main chain in the ester moiety. The unit derived from the (meth)acrylic monomer can provide an additional adhesion improvement effect.

The unit derived from the (meth)acrylic monomer is represented by the following Chemical Formula 3, and the copolymer may include one or more units represented by the following Chemical Formula 3:

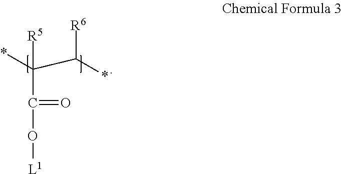

In Chemical Formula 3,
R⁵ and R⁶ each independently is or includes hydrogen or a methyl group, and
L¹ is or includes a substituted or unsubstituted, straight or branched C1 to C3 alkyl group).

In an example, the (meth)acrylic monomer may include one or more of methyl (meth)acrylate, ethyl (meth)acrylate, n-propyl (meth)acrylate, and iso-propyl (meth)acrylate.

For example, a homopolymer of the (meth)acrylic monomer may have a glass transition temperature of about 50° C. or higher, for example, about 50° C. to about 150° C. In the above range, a glass transition temperature of the above-described copolymer can be readily reached. For example, the (meth)acrylic monomer may be or include methyl methacrylate, ethyl methacrylate, or the like.

The first structural unit is included in an amount in a range of about 5 mol % to about 80 mol % with respect to 100 mol % of the copolymer. When the first structural unit is included in an amount of about 5 mol % or more, electrolyte wettability can be improved, and a capacity retention rate at high temperature can be high. When the first structural unit is included in an amount of about 80 mol % or less, membrane resistance cannot be increased, and a capacity retention rate at room temperature and high temperature can be high. For example, the first structural unit may be included in an amount in a range of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79.80 mol %, about 10 mol % to about 70 mol %, or 30 mol % to 60 mol % with respect to 100 mol % of the copolymer. When the first structural unit is included in the above range, the separator can exhibit low membrane resistance, desired or improved adhesion to a porous substrate and an electrode, air permeability, and oxidation resistance.

The unit derived from an aromatic based unsaturated monomer may be included in an amount in a range of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79.80 mol %, about 5 mol % to about 80 mol %, for example, 10 mol % to 70 mol %, 10 mol % to 60 mol %, 10 mol % to 35 mol %, 15 mol % to 30 mol %, or 5 mol % to 35 mol % with respect to 100 mol % of the copolymer. In the above range, the above-described effects of the separator can be readily implemented.

The unit derived from the (meth)acrylic monomer may be included in an amount in a range of about 5 mol % to about 80 mol %, for example, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79.80 mol %, 10 mol % to 70 mol %, 10 mol % to 60 mol %, 10 mol % to 35 mol %, 15 mol % to 30 mol %, or 5 mol % to 35 mol % with respect to 100 mol % of the copolymer. In the above range, the above-described effects of the separator can be readily implemented.

According to an example embodiment, the unit derived from an aromatic based unsaturated monomer and the unit derived from the (meth)acrylic monomer may be included in a molar ratio in a range of about 1:0.5 to about 1:2, for example, 1:0.5, 1:0.6, 1:0.7, 1:0.8, 1:0.9, 1:1, 1:1.1, 1:1.2, 1:1.3, 1:1.4, 1:1.5, 1:1.6, 1:1.7, 1:1.8, 1:1.9, 1:2, 1:1 to 1:2 or 1:1 with respect to 100 mol % of the copolymer. In the above range, the above-described effects of the separator can be readily implemented.

### Second Structural Unit:

The second structural unit is derived from a (meth)acrylic monomer containing an alkyl group having 4 or more carbon atoms in the main chain in the ester moiety. The second structural unit can improve the dispersibility of a coating layer slurry and also improve the electrolyte wettability and flexibility of the coating layer.

The unit derived from the (meth)acrylic monomer is represented by the following Chemical Formula 4, and the copolymer may include one or more structural units represented by the following Chemical Formula 4:

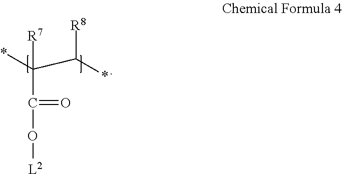

In Chemical Formula 4,
R⁷ and R⁸ each independently is or includes hydrogen or a methyl group, and
L² is or includes a substituted or unsubstituted, straight or branched C4 to C30 alkyl group).

In this case, the alkyl group may be or include a C4 to C20 alkyl group, a C4 to C10 alkyl group, or a C4 to C8 alkyl group.

According to an example embodiment, the (meth)acrylic monomer may include one or more of 2-ethylhexyl (meth)acrylate, n-butyl (meth)acrylate, iso-butyl (meth)acrylate, tert-butyl (meth)acrylate, pentyl (meth)acrylate, hexyl (meth)acrylate, heptyl (meth)acrylate, n-octyl (meth)acrylate, nonyl (meth)acrylate, isononyl (meth)acrylate, decyl (meth)acrylate, and isodecyl (meth)acrylate.

The second structural unit is included in an amount in a range of about 10 mol % to about 40 mol % with respect to 100 mol % of the copolymer. When the second structural unit is included in an amount of about 10 mol % or more, membrane resistance can decrease upon impregnation with an electrolyte, and a capacity retention rate at room temperature and high temperature can be high. When the second structural unit is included in an amount of about 40 mol % or less, air permeability can be improved, and a capacity retention rate at room temperature and high temperature can be high.

For example, the second structural unit may be included in an amount in a range of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 mol %, about 15 mol % to about 35 mol %, for example, 20 mol % to 30 mol % with respect to 100 mol % of the copolymer. In the above range, it can be possible to increase the adhesion to a porous substrate and an electrode and flexibility of the coating layer.

### Third Structural Unit:

The third structural unit is derived from a sulfonic acid group-containing monomer. The unit derived from a sulfonic acid group-containing monomer can decrease the membrane resistance of the separator by increasing the possibility of lithium ion movement in the presence of the first structural unit and the second structural unit.

According to an example embodiment, the third structural unit increases the glass transition temperature of the copolymer by including a bulky functional group derived from (meth)acrylamido sulfonic acid or a salt thereof, and thus structural safety is provided. Also, when the third structural unit is a functional group derived from a salt of (meth)acrylamido sulfonic acid, a metal (M) may move through the third structural unit by a sulfonic acid functional group substituted with the metal, and thus the membrane resistance of the separator can significantly decrease.

The third structural unit may be represented by the following Chemical Formula 5, 6, or 7. The copolymer may include one or more third structural units represented by the following Chemical Formulas 5, 6, and 7:

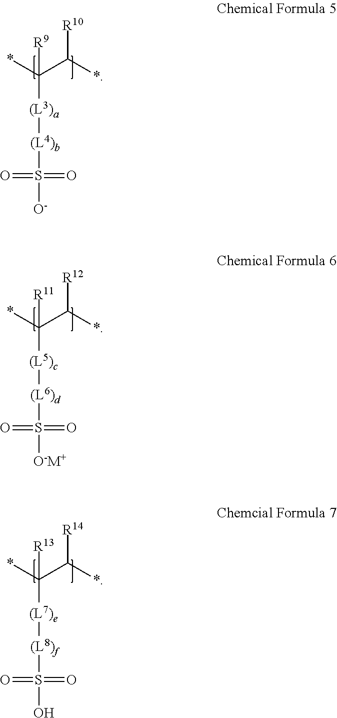

In Chemical Formulas 5 to 7,
R⁹, R¹⁰, R¹¹, R¹², R¹³, and R¹⁴ each independently is or includes hydrogen or a C1 to C3 alkyl group,
L³, L⁵, and L⁷ each independently is or includes —C(═O)—, —C(═O)O—, —OC(═O)—, —O—, or —C(═O)NH—,
L⁴, L⁶, and L⁸ each independently is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
a, b, c, d, e, and f are each independently an integer in a range from 0 to 2, and
in Chemical Formula 6,
M is or includes an alkali metal.

In an example, in Chemical Formulas 5 to 7,
L³, L⁵, and L⁷ may each independently be or include —C(═O)NH—,
L⁴, L⁶, and L⁸ may each independently be or include a C1 to C10 alkylene group, and
a, b, c, d, e, and f may be equal to 1.

The sulfonic acid group-containing structural unit may include only one of the structural units represented by Chemical Formulas 5 to 7, or two or more thereof. In an example, the sulfonic acid group-containing structural unit may include the structural unit represented by Chemical Formula 6, and in another example, the sulfonic acid group-containing structural unit may include the structural unit represented by Chemical Formula 6 and the structural unit represented by Chemical Formula 7.

The sulfonic acid group-containing structural unit may be or include, for example, a structural unit derived from vinyl sulfonic acid, allyl sulfonic acid, styrene sulfonic acid, anethol sulfonic acid, (meth)acrylamido alkane sulfonic acid, sulfoalkyl (meth)acrylate, or a salt thereof.

Herein, the alkane may be or include a C1 to C20 alkane, a C1 to C10 alkane, or a C1 to C6 alkane, and the alkyl may be or include a C1 to C20 alkyl, a C1 to C10 alkyl, or a C1 to C6 alkyl. The salt refers to a salt constituted by the above-described sulfonic acid and appropriate ions. The ion may be or include, for example, an alkali metal ion, and in this case, the salt may be or include a sulfonic acid alkali metal salt.

The (meth)acrylamido alkane sulfonic acid may be or include, for example, at least one of 2-(meth)acrylamido-2-methylpropane sulfonic acid, and the sulfoalkyl (meth)acrylate may be or include, for example, at least one of 2-sulfoethyl (meth)acrylate, 3-sulfopropyl (meth)acrylate, or the like.

The third structural unit is included in an amount in a range of about 5 mol % to about 80 mol % with respect to 100 mol % of the copolymer. When the third structural unit is included in an amount of about 5 mol % or more, the membrane resistance of the separator can decrease, and the DC-IR change rate at room temperature and high temperature can decrease. When the third structural unit is included in an amount of about 80 mol % or less, the capacity retention rate of a battery at room temperature and high temperature can increase, and the DC-IR change rate at room temperature and high temperature can decrease.

For example, the third structural unit may be included in an amount in a range of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79.80 mol %, about 10 mol % to about 60 mol % with respect to 100 mol % of the copolymer. For example, the third structural unit may be included in an amount in a range of about 20 mol % to about 60 mol %, or 30 mol % to 60 mol % with respect to 100 mol % of the copolymer. When the third structural unit is included in the above range, the membrane resistance of the binder and the separator including the binder can significantly decrease, the capacity retention rate of a battery at room temperature and high temperature can increase, and the DC-IR change rate at room temperature and high temperature can decrease.

The binder may include an alkali metal. The alkali metal may be present in the form of a cation and may be or include, for example, at least one of lithium, sodium, potassium, rubidium, or cesium. For example, the alkali metal may be present in the form of a salt by being combined with the copolymer. The alkali metal can help the synthesis of the monomer mixture into the copolymer in an aqueous solvent and improve the adhesion of the coating layer, the air permeability of the separator, the oxidation resistance, and the like.

The copolymer may have a glass transition temperature in a range of about 60° C. to about 80° C. In an example, the glass transition temperature may be 60, 61, 62, 63, 64, 65, 66, 67, 68, 69, 70, 71, 72, 73, 74, 75, 76, 77, 78, 79, 80° C., 62° C. to 78° C., for example, 64° C. to 75° C. In the above range, the coating layer can have desired or improved adhesion, and a separator including the coating layer can exhibit desired or improved air permeability and oxidation resistance. The glass transition temperature of the copolymer may be measured by a typical method known to those skilled in the art, such as, e.g., thermomechanical analysis (TMA). For example, the glass transition temperature can be measured as follow:
1. Cut the copolymer or the binder to be analyzed to a size of 0.5 mm×8 mm to prepare a sample, attach it to the holder, and place it on a sample probe of the TMA equipment.
2. Set the mechanical load to 0.0150 N and the heating rate to 5° C./min, and measure the change in the sample length according to temperature.
3. The temperature at which the slope of the graph obtained from the TMA equipment changes is designated as the glass transition temperature.

The copolymer may be included in an amount in a range of about 1 wt % to about 90 wt %, for example, 5 wt % to 80 wt %, or 10 wt % to 80 wt % with respect to the total amount of the coating layer. In the above range, adhesion to an electrode can be exhibited, and there can be no limitation on capacity implementation because battery resistance is not increased.

The alkali metal may be included in an amount in a range of about 1 wt % to about 40 wt %, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39.40 wt %, 1 wt % to 30 wt %, 1 wt % to 20 wt %, or 10 wt % to 20 wt % in the binder including the alkali metal and the copolymer. For example, the copolymer and the alkali metal may be included in a weight ratio in a range of about 99:1 to about 60:40, or 99:1 to 70:30, for example, a weight ratio in a range of 99:1 to 80:20 or 90:10 to 80:20.

The alkali metal may be included in an amount in a range of about 0.1 mol % to about 1.0 mol % with respect to the total amount of the alkali metal and the copolymer of the monomer mixture. When the alkali metal is included in the above range, the coating layer can have desired or improved adhesion, and a separator including the coating layer can exhibit desired or improved air permeability and oxidation resistance.

The binder including the copolymer of the monomer mixture may be in various forms such as an alternating polymer in which the structural units are alternately distributed, a random polymer in which the structural units are randomly distributed, and a graft polymer in which some structural units are grafted, and the like.

The binder including the copolymer of the monomer mixture may have a weight average molecular weight in a range of about 100,000 g/mol to about 1,000,000 g/mol, 100,000 g/mol to 500,000 g/mol, 100,000 g/mol to 150,000 g/mol, 200,000 g/mol to 130,000 g/mol, or 300,000 g/mol to 900,000 g/mol. When the weight average molecular weight of the binder including the copolymer of the monomer mixture satisfies the above range, desired or improved adhesion and low resistance can be exhibited. The weight average molecular weight may be or include a polystyrene-converted average molecular weight measured using gel permeation chromatography.

The binder including the copolymer of the monomer mixture may be prepared by solution polymerization.

According to an example embodiment, the binder including the copolymer of the monomer mixture may be included in the form of a film in the coating layer of the separator.

### First Filler

The first filler may have an average particle size D50 of more than 0 nm and less than about 100 nm, for example, a range of 5, 10, 15, 20, 25, 30, 35, 40, 45, 50, 55, 60, 65, 70, 75, 80, 85, 90, 95, 99 nm, about 10 nm to about 90 nm, 10 nm to 80 nm, 20 nm to 60 nm, or 50 nm. In the above range, the above-described Expression 1 can be readily satisfied.

In an example, the first filler may have a specific surface area of about 50 m²/g or more, for example, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200 m²/g, a range of about 60 m²/g to about 200 m²/g, or 60 m²/g to 150 m²/g. In the above range, the above-described effects of the separator can be readily implemented. In this specification, a “specific surface area” may refer to a Brunauer-Emmett-Teller (BET) specific surface area and may be measured by a typical method known to those skilled in the art.

In an example, the first filler may have a pH of about 7 or higher, for example, 7, 7.5, 8, 8.5, 9, a pH in a range of about 7 to about 9. In the above range, the above-described effects of the separator can be readily implemented. In this specification, the pH of the filler may be measured using a pH meter.

For example, the pH of the filler is measured for a solution obtained by dissolving the filler in pure water using a pH meter. For example, the pH may be measured using a pH meter for a solution obtained by inputting 10 g of the filler into 100 ml of pure water, allowing the mixture to stand at room temperature for 30 days, and removing the filler. The pH meter may be used according to a typical method known to those skilled in the art.

In an example, the first filler may be amorphous. The amorphous filler may preferably include boehmite (particle size D50: 50 nm).

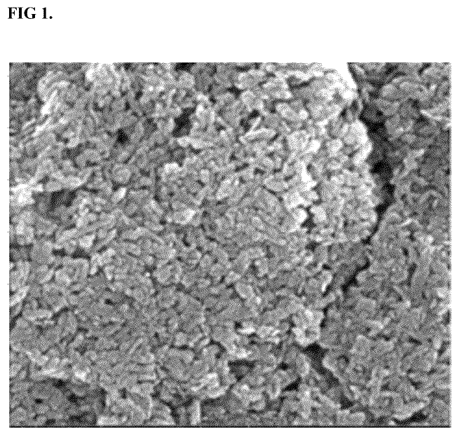

FIG. 1 is a scanning electron microscope (SEM) image of an amorphous filler. Referring to FIG. 1, an amorphous filler may have an irregular shape, not a constant or uniform shape.

The first filler may be or include, for example, an inorganic filler, an organic filler, an organic/inorganic composite filler, or a combination thereof. The inorganic filler may be or include a ceramic material capable of improving heat resistance. The inorganic filler may include, for example, at least one of a metal oxide, a metalloid oxide, a metal fluoride, a metal hydroxide, or a combination thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but the present disclosure is not limited thereto. The organic filler may include at least one of an acrylic compound, an imide compound, an amide compound, or a combination thereof, but the present disclosure is not limited thereto. The organic filler may have a core-shell structure, but the present disclosure is not limited thereto.

For example, the first filler may be or include boehmite.

The first filler may be included in an appropriate amount with respect to the first binder, for example, the copolymer. According to an example embodiment, the copolymer and the first filler may be included in a mass ratio in a range of about 1:10 to about 1:50, for example, 1:10, 1:15, 1:20, 1:25, 1:30, 1:35, 1:40, 1:45, 1:50, 1:20 to 1:30. In the above range, an effect of improving heat resistance in an electrolyte can be achieved.

The first filler may be included in an amount in a range of about 50 wt % to about 99 wt %, for example, 70 wt % to 99 wt %, 75 wt % to 99 wt %, 80 wt % to 99 wt %, 85 wt % to 99 wt %, 90 wt % to 99 wt %, or 95 wt % to 99 wt % with respect of the total amount of the first coating layer. When the first filler is included in the above range, desired or improved heat resistance, durability, oxidation resistance, and stability can be exhibited.

The first coating layer may have a thickness in a range of about 0.01 μm to about 20 μm. In the above range, the thickness may be in a range of about 0.01 μm to about 5 μm, 0.1 μm to 3 μm, or 0.1 μm to 1.5 μm. In the above range, the first coating layer can be used in the separator.

A ratio of the thickness of the first coating layer to the thickness of the porous substrate may be in a range of about 0.1 to about 0.8, for example, 0.1 to 0.7 or 0.15 to 0.6. In the above range, the separator can exhibit desired or improved air permeability, heat resistance, and adhesion.

### Second Coating Layer

The second coating layer includes a binder and a filler, wherein the binder includes a second binder, and the filler includes a second filler. The second filler and the second binder may be dispersed in the second coating layer.

In an example, the second binder may be included in an amount of about 95 wt % or more, for example, in a range of about 95 wt % to about 100 wt % or 100 wt % of the total binder in the second coating layer. In the above range, the above-described effects of the separator can be readily implemented.

In an example, the second filler may be included in an amount of about 95 wt % or more, for example, in a range of about 95 wt % to about 100 wt % or 100 wt % of the total filler in the second coating layer. In the above range, the above-described effects of the separator can be readily implemented.

### Second Binder

The second binder may include the first structural unit, the second structural unit, and the third structural unit in a total amount of about 95 mol % or more, for example, a range of about 95 mol % to about 100 mol %, or 100 mol %. In the above range, the above-described effects of the separator can be readily implemented.

The first structural unit, the second structural unit, and the third structural unit are substantially the same as the first, second and third structural units described above with respect to the first binder. Therefore, the descriptions for the first binder may also be applied for the second binder.

In an example, the first structural unit content of the second binder may be the same as or different from the first structural unit content of the first binder. In an example, the second structural unit content of the second binder may be the same as or different from the second structural unit content of the first binder. In an example, the third structural unit content of the second binder may be the same as or different from the third structural unit content of the first binder.

In an example, the first structural unit type of the second binder may be the same as or different from the first structural unit type of the first binder. In an example, the second structural unit type of the second binder may be the same as or different from the second structural unit type of the first binder. In an example, the third structural unit type of the second binder may be the same as or different from the third structural unit type of the first binder.

### Second Filler

The second filler may have an average particle size D50 of about 100 nm or more and about 300 nm or less, for example, 100, 110, 120, 130, 140, 150, 160, 170, 180, 190, 200, 210, 220, 230, 240, 250, 260, 270, 280, 290, 300 nm, in a range of about 180 nm to about 220 nm, 130 nm to 160 nm, or 150 nm. In the above range, the above-described Expression 1 can be readily satisfied.

In an example, the second filler may have a specific surface area of about 50 m²/g or less, for example, 5, 10, 15, 20, 25, 30, 35, 40, 45, 50 m²/g, in a range of about 10 m²/g to about 50 m²/g or 10 m²/g to 30 m²/g. In the above range, the above-described effects of the separator can be readily implemented.

In an example, the second filler may have a pH of about 7 or higher, for example, 7, 7.5, 8, 8.5, 9, a pH in a range of about 7 to about 9.

In an example, the second filler may be cubic. The cubic filler may preferably include boehmite (particle size D50: 150 nm).

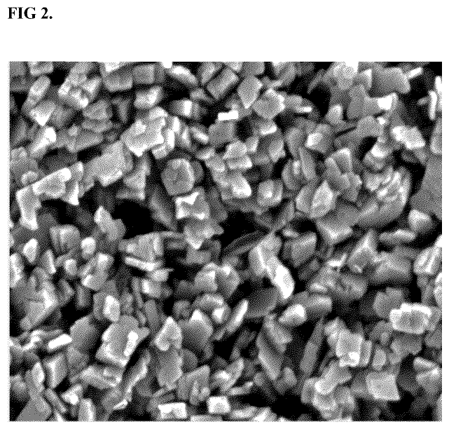

FIG. 2 is an SEM image of a cubic filler. Referring to FIG. 2, a cubic filler may have a shape with angled corners and opposing quadrangular faces, such as a rectangle or a square.

The second filler may be or include, for example, an inorganic filler, an organic filler, an organic/inorganic composite filler, or a combination thereof. The inorganic filler may be or include a ceramic material capable of improving heat resistance. The inorganic filler may include, for example, at least one of a metal oxide, a metalloid oxide, a metal fluoride, a metal hydroxide, or a combination thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but the present disclosure is not limited thereto. The organic filler may include at least one of an acrylic compound, an imide compound, an amide compound, or a combination thereof, but the present disclosure is not limited thereto. The organic filler may have a core-shell structure, but the present disclosure is not limited thereto.

For example, the second filler may be or include boehmite.

The second filler may be included in an appropriate amount with respect to the second binder, for example, the copolymer. According to an example embodiment, the copolymer and the second filler may be included in a mass ratio in a range of about 1:10 to about 1:50, for example, 1:10, 1:15, 1:20, 1:25, 1:30, 1:35, 1:40, 1:45, 1:50, 1:20 to 1:30. In the above range, an effect of improving heat resistance in an electrolyte can be achieved.

The second filler may be included in an amount in a range of about 50 wt % to about 99 wt %, for example, 70 wt % to 99 wt %, 75 wt % to 99 wt %, 80 wt % to 99 wt %, 85 wt % to 99 wt %, 90 wt % to 99 wt %, or 95 wt % to 99 wt % with respect of the total amount of the second coating layer. When the second filler is included in the above range, desired or improved heat resistance, durability, oxidation resistance, and stability can be exhibited.

The second coating layer may have a thickness in a range of about 0.01 μm to about 20 μm. In the above range, the thickness may be 0.01 μm to 5 μm, 0.1 μm to 3 μm, or 0.1 μm to 1.5 μm. In the above range, the second coating layer may be used in the separator.

A ratio of the thickness of the second coating layer to the thickness of the porous substrate may be in a range of about 0.1 to about 0.8, for example, 0.1 to 0.7 or 0.15 to 0.6. In the above range, the separator can exhibit desired or improved air permeability, heat resistance, and adhesion.

### Porous Substrate

The porous substrate may be or include a substrate that has many pores, and is typically used in electrochemical devices. The porous substrate may be or include, but is not limited, a polymer membrane formed of or including any one or more of a polyolefin such as polyethylene, polypropylene, or the like, a polyester such as polyethylene terephthalate, polybutylene terephthalate, polyethylene naphthalate, or the like, polyacetal, polyamide, polyimide, polycarbonate, polyetheretherketone, polyaryletherketone, polyetherimide, polyamideimide, polybenzimidazole, polyethersulfone, polyphenylene oxide, a cyclic olefin copolymer, polyphenylene sulfide, glass fiber, Teflon, and polytetrafluoroethylene, or a copolymer or mixture of two or more thereof.

The porous substrate may be or include, for example, a polyolefin-based substrate including a polyolefin, and the polyolefin-based substrate can contribute to improving the safety of a battery due to the desired or improved shutdown function thereof. The polyolefin-based substrate may be or include, for example, at least one of a polyethylene single-layer film, a polypropylene single-layer film, a polyethylene/polypropylene double-layer film, a polypropylene/polyethylene/polypropylene triple-layer film, and a polyethylene/polypropylene/polyethylene triple-layer film. Also, the polyolefin-based resin may include a non-olefin resin in addition to an olefin resin, or include a copolymer of olefin and non-olefin monomers.

The porous substrate may have a thickness in a range of about 1 μm to about 40 μm, for example, 1 μm to 30 μm, 1 μm to 20 μm, or 5 μm to 15 μm.

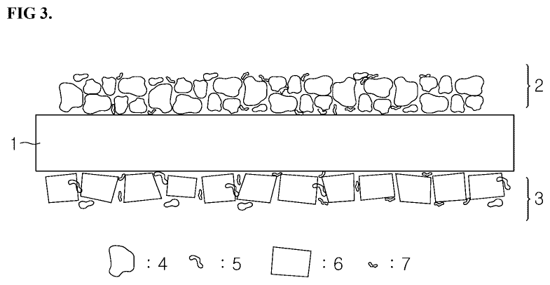

FIG. 3 is a cross-sectional view of a separator for a rechargeable lithium battery according to an example embodiment of the present disclosure. Referring to FIG. 3, a separator includes a porous substrate 1, a first coating layer 2 located on the first surface of the porous substrate 1, and a second coating layer 3 located on the second surface of the porous substrate 1. The first coating layer 2 may include a first filler 4 and a first binder 5. The second coating layer 3 may include a second filler 6 and a second binder 7.

### Separator Manufacturing Method

A separator for a rechargeable lithium battery may be manufactured by coating a first surface of a porous substrate with a composition for a first coating layer to form a coating film for a first coating layer, coating a second surface of the porous substrate with a composition for a second coating layer to form a coating film for a second coating layer, and drying the two coating films.

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be positioned between the positive electrode and the negative electrode.

### Positive Electrode

A positive electrode for a rechargeable lithium battery may include a current collector, and a positive electrode active material layer on the current collector. The positive electrode active material layer may include a positive electrode active material, and may further include a binder and/or a conductive material.

For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}CO_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<<α2); LiₐNi_{b}Co_{c}L¹_{d}GₑO₂ (0.90≤a≤1.8, 0≤b≤0.9, 0<α<0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., does not cause an undesirable chemical change in the rechargeable lithium battery), and that conducts electrons, can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing copper, nickel, aluminum, silver, and the like, in a form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be or include graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material, or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., does not cause an undesirable chemical change in the rechargeable lithium battery), and that conducts electrons, can be used in the battery. Non-limiting examples thereof may include a carbon-based material such as or including at least one of natural graphite, artificial graphite, carbon black, acetylene black, ketjen black, a carbon fiber, a carbon nanofiber, and a carbon nanotube; a metal-based material including copper, nickel, aluminum, silver, and the like, in the form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LIN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

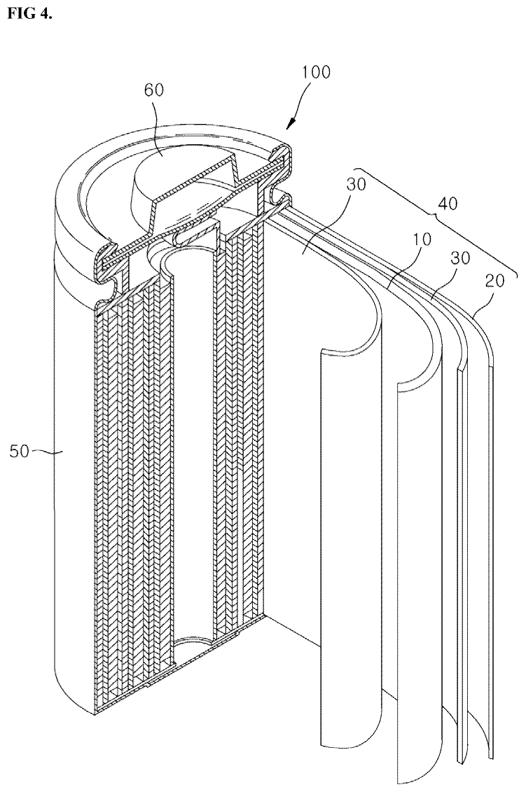

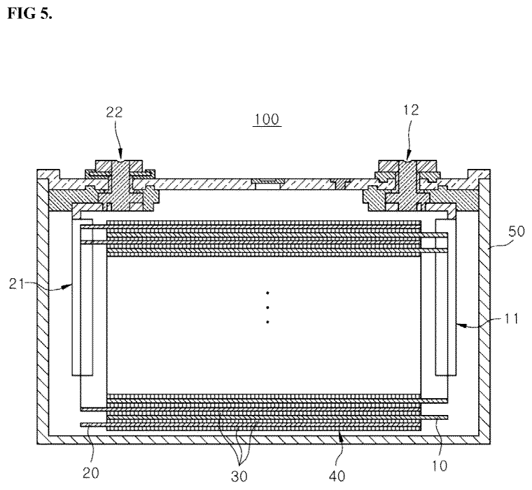

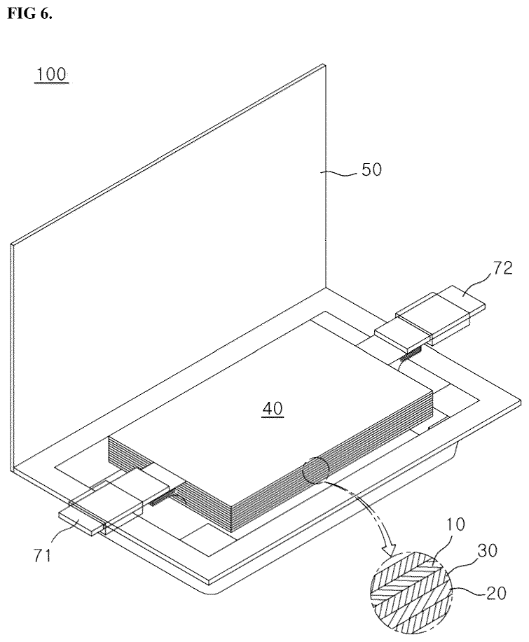

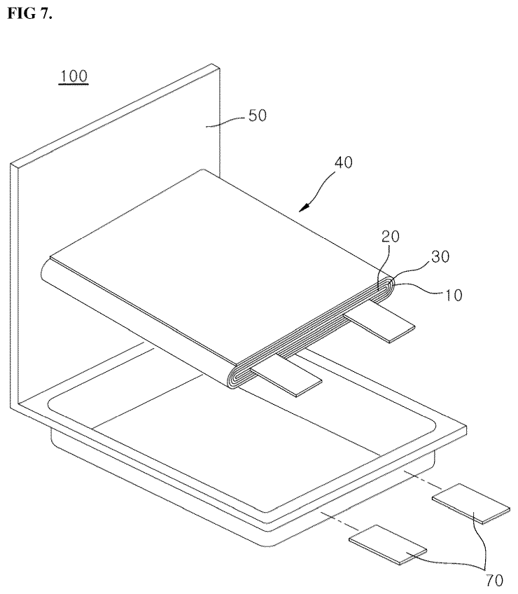

FIG. 4 to FIG. 7 are schematic views illustrating a rechargeable lithium battery according to an example embodiment. FIG. 4 shows a cylindrical battery, FIG. 5 shows a prismatic battery, and FIG. 6 and FIG. 7 show pouch-type batteries. Referring to FIG. 4 to FIG. 7, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 4. In FIG. 5, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 6 and FIG. 7, the rechargeable lithium battery 100 may include an electrode tab 70 illustrated in FIG. 7, or for example, a positive electrode tab 71 and a negative electrode tab 72 illustrated in FIG. 6, the electrode tabs 70/71/72 forming an electric path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, examples and comparative examples of the present disclosure are described. The following examples are given for the purpose of illustration only and are not intended to limit the scope of the present disclosure.

### REFERENCE EXAMPLES

### Preparation Example 1

Into a 3 L 4-neck separable flask equipped with a stirrer, a thermometer, and a condenser, distilled water (1249.72 g), a 20% aqueous lithium hydroxide solution (203.69 g), styrene (SM, 36.45 g, 0.35 mol), methyl methacrylate (MMA, 35.04 g, 0.35 mol), 2-ethylhexyl acrylate (EHA, 36.83 g, 0.20 mol), and 2-acrylamido-2-methylpropane sulfonic acid (AMPS, 20.73 g, 0.10 mol) were input, sodium dodecylbenzenesulfonate (16.02 g, 0.05 mol) was added, and then a process of reducing a pressure inside the flask to 10 mmHg using a diaphragm pump and returning the internal pressure with nitrogen to atmospheric pressure was repeated three times.

A reaction was performed for 12 hours while controlling heating so that the temperature of a reaction solution was stably maintained at 65° C. to 70° C.

After cooling to room temperature, about 10 mL of the reaction solution was taken, and a non-volatile (NV) component was measured. As a result, a particulate copolymer having an NV component content of 9.8 wt % (theoretical value: 10 wt %) was obtained. In the case of the obtained copolymer, poly(SM-co-MMA-co-EHA-co-AMPS) lithium salt, a molar ratio of a first structural unit derived from SM and MMA, a second structural unit derived from EHA, and a third structural unit derived from AMPS was 70:20:10, the particle size was 500 nm, and the glass transition temperature (Tg) of the copolymer was 65.1° C.

### Preparation Example 2

A copolymer was prepared in the same manner as in Preparation Example 1, with a difference that SM (30.20 g, 0.29 mol), MMA (29.04 g, 0.29 mol), EHA (40.52 g, 0.22 mol), and AMPS (41.45 g, 0.20 mol) were used, and the glass transition temperature of the copolymer was 65.0° C. A molar ratio of the SM-co-MMA-co-EHA-co-AMPS lithium salt was 29:29:22:20. The NV component content in the reaction solution was 9.0 wt % (theoretical value: 10 wt %).

### Preparation Example 3

An acrylic copolymer was prepared in the same manner as in Preparation Example 1, with a difference that SM (23.95 g, 0.23 mol), MMA (23.03 g, 0.23 mol), EHA (44.20 g, 0.24 mol), and AMPS (62.18 g, 0.30 mol) were used, and the glass transition temperature of the copolymer was 64.0° C. A molar ratio of the SM-co-MMA-co-EHA-co-AMPS lithium salt was 23:23:24:30. The NV component content in the reaction solution was 9.0 wt % (theoretical value: 10 wt %).

### Preparation Example 4

An acrylic copolymer was prepared in the same manner as in Preparation Example 1, with a difference that SM (17.71 g, 0.17 mol), MMA (35.04 g, 0.17 mol), EHA (47.88 g, 0.26 mol), and AMPS (82.9 g, 0.40 mol) were used, and the glass transition temperature (Tg) of the copolymer was 64.8° C. A molar ratio of the SM-co-MMA-co-EHA-co-AMPS lithium salt was 17:17:26:40. The NV component content in the reaction solution was 9.0 wt % (theoretical value: 10 wt %).

### Preparation Example 5

An acrylic copolymer was prepared in the same manner as in Preparation Example 1, with a difference that SM (11.46 g, 0.11 mol), MMA (11.01 g, 0.11 mol), EHA (51.56 g, 0.28 mol), and AMPS (103.63 g, 0.50 mol) were used, and the glass transition temperature (Tg) of the copolymer was 64.7° C. A molar ratio of the SM-co-MMA-co-EHA-co-AMPS lithium salt was 11:11:28:50. The NV component content in the reaction solution was 9.0 wt % (theoretical value: 10 wt %).

### Preparation Example 6

An acrylic copolymer was prepared in the same manner as in Preparation Example 1, with a difference that SM (5.21 g, 0.05 mol), MMA (5.01 g, 0.05 mol), EHA (55.25 g, 0.30 mol), and AMPS (124.35 g, 0.60 mol) were used, and the glass transition temperature (Tg) of the copolymer was 64.6° C. A molar ratio of the SM-co-MMA-co-EHA-co-AMPS lithium salt was 5:5:30:60. The NV component content in the reaction solution was 9.0 wt % (theoretical value: 10 wt %).

### Preparation Example 7

An acrylic copolymer was prepared in the same manner as in Preparation Example 1, with a difference that SM (20.83 g, 0.20 mol), EHA (55.28 g, 0.30 mol), and AMPS (103.63 g, 0.50 mol) were used without MMA, and the glass transition temperature (Tg) of the copolymer was 60.0° C. A molar ratio of the SM-co-EHA-co-AMPS lithium salt was 20:30:50. The NV component content in the reaction solution was 9.0 wt % (theoretical value: 10 wt %).

### Comparative Preparation Example 1

An acrylic copolymer was prepared in the same manner as in Preparation Example 1, with a difference that SM (2.08 g, 0.02 mol), MMA (2 g, 0.02 mol), EHA (55.28 g, 0.30 mol), and AMPS (136.785 g, 0.66 mol) were used, and the glass transition temperature (Tg) of the copolymer was 67.1° C. A molar ratio of the SM-co-MMA-co-EHA-co-AMPS lithium salt was 2:2:30:66. The NV component content in the reaction solution was 9.0 wt % (theoretical value: 10 wt %).

### Comparative Preparation Example 2

An acrylic copolymer was prepared in the same manner as in Preparation Example 1, with a difference that SM (44.26 g, 0.425 mol), MMA (42.55 g, 0.425 mol), EHA (18.43 g, 0.10 mol), and AMPS (10.36 g, 0.05 mol) were used, and the glass transition temperature (Tg) of the copolymer was 85.5° C. A molar ratio of the SM-co-MMA-co-EHA-co-AMPS lithium salt was 42.5:42.5:10:5. The NV component content in the reaction solution was 9.0 wt % (theoretical value: 10 wt %).

### Comparative Preparation Example 3

An acrylic copolymer was prepared in the same manner as in Preparation Example 1, with a difference that SM (41.66 g, 0.40 mol), MMA (40.05 g, 0.40 mol), EHA (9.21 g, 0.05 mol), and AMPS (31.09 g, 0.15 mol) were used, and the glass transition temperature (Tg) of the copolymer was 102.97° C. A molar ratio of the SM-co-MMA-co-EHA-co-AMPS lithium salt was 40:40:5:15. The NV component content in the reaction solution was 9.0 wt % (theoretical value: 10 wt %).

### Comparative Preparation Example 4

An acrylic copolymer was prepared in the same manner as in Preparation Example 1, with a difference that SM (20.83 g, 0.20 mol), MMA (20.02 g, 0.20 mol), EHA (82.93 g, 0.45 mol), and AMPS (31.09 g, 0.15 mol) were used, and the glass transition temperature (Tg) of the copolymer was 20.7° C. A molar ratio of the SM-co-MMA-co-EHA-co-AMPS lithium salt was 20:20:45:15. The NV component content in the reaction solution was 9.0 wt % (theoretical value: 10 wt %).

### Comparative Preparation Example 5

An acrylic copolymer was prepared in the same manner as in Preparation Example 1, with a difference that SM (41.66 g, 0.40 mol), MMA (40.05 g, 0.40 mol), EHA (32.25 g, 0.175 mol), and AMPS (5.18 g, 0.025 mol) were used, and the glass transition temperature (Tg) of the copolymer was 67.3° C. A molar ratio of the SM-co-MMA-co-EHA-co-AMPS lithium salt was 40:40::17.5:2.5. The NV component content in the reaction solution was 9.0 wt % (theoretical value: 10 wt %).

### Comparative Preparation Example 6

An acrylic copolymer was prepared in the same manner as in Preparation Example 1, with a difference that SM (2.6 g, 0.025 mol), MMA (2.5 g, 0.025 mol), EHA (18.43 g, 0.10 mol), and AMPS (176.16 g, 0.85 mol) were used, and the glass transition temperature (Tg) of the copolymer was 127.3° C. A molar ratio of the SM-co-MMA-co-EHA-co-AMPS lithium salt was 2.5:2.5:10:85. The NV component content in the reaction solution was 9.0 wt % (theoretical value: 10 wt %).

The following Table 1 shows the molar ratio of monomers in the binders prepared in Preparation Examples 1 to 7 and Comparative Preparation Examples 1 to 6.

TABLE 1

| | Molar ratio of monomers | | | | Tg |
|---|---|---|---|---|---|
| | SM | MMA | EHA | AMPS | (° C.) |
| Preparation Example 1 | 35 | 35 | 20 | 10 | 65.1 |
| Preparation Example 2 | 29 | 29 | 22 | 20 | 65.0 |
| Preparation Example 3 | 23 | 23 | 24 | 30 | 64.0 |
| Preparation Example 4 | 17 | 17 | 26 | 40 | 64.8 |
| Preparation Example 5 | 11 | 11 | 28 | 50 | 64.7 |
| Preparation Example 6 | 5 | 5 | 30 | 60 | 64.6 |
| Preparation Example 7 | 20 | 0 | 30 | 50 | 60.0 |
| Comparative Preparation | 2 | 2 | 30 | 66 | 67.1 |
| Example 1 | | | | | |
| Comparative Preparation | 42.5 | 42.5 | 10 | 5 | 85.5 |
| Example 2 | | | | | |
| Comparative Preparation | 40 | 40 | 5 | 15 | 102.9 |
| Example 3 | | | | | |
| Comparative Preparation | 20 | 20 | 45 | 15 | 20.7 |
| Example 4 | | | | | |
| Comparative Preparation | 40 | 40 | 17.5 | 2.5 | 67.3 |
| Example 5 | | | | | |
| Comparative Preparation | 2.5 | 2.5 | 10 | 85 | 127.3 |
| Example 6 | | | | | |

### Reference Example 1

10 parts by weight of the binder of Preparation Example 1 and 90 parts by weight of distilled water were mixed to prepare a coating layer composition.

The prepared coating layer composition was applied onto both sides of a polyethylene-based film (commercially available from CZMZ, thickness: 5.5 μm, air permeability: 110 sec/100 cc, puncture strength: 360 kgf) as a porous substrate at a speed of 80 m/min by a die coating method, and then dried at 60° C. under an absolute water vapor content (average value) of 14 g/m³ to form a coating layer with a total thickness of 1.4 μm, thereby manufacturing a separator for a rechargeable lithium battery.

### Reference Examples 2 to 7

Separators for a rechargeable lithium battery were manufactured in the same manner as in Reference Example 1, with a difference that the type of binder was changed.

### Comparative Reference Examples 1 to 6

Separators for a rechargeable lithium battery were manufactured in the same manner as in Reference Example 1, with a difference that the type of binder was changed.

### Manufacture of Battery

### Manufacture of Negative Electrode:

97 wt % of graphite particles having an average particle size of 25 μm as a negative electrode material, 1.5 wt % of a styrene-butadiene rubber (SBR) binder, and 1.5 wt % of carboxy methyl cellulose (CMC) were mixed, and the mixture was added to distilled water and stirred using a mechanical stirrer for 60 minutes to prepare a negative electrode active material slurry. The slurry was applied onto a 10 μm-thick copper current collector using a doctor blade, dried in a hot air dryer set at 100° C. for 0.5 hours, additionally dried under vacuum at 120° C. for 4 hours, and roll-pressed to manufacture a negative electrode.

### Manufacture of Positive Electrode:

97 wt % of LiCoO₂ as a positive electrode material, 1.5 wt % of carbon black powder as a conductive material, and 1.5 wt % of polyvinylidene fluoride (PVdF) were mixed, and the mixture was added to an N-methyl-2-pyrrolidone solvent and stirred using a mechanical stirrer for 30 minutes to prepare a positive electrode active material slurry. The slurry was applied onto a 20 μm-thick aluminum current collector using a doctor blade, dried in a hot air dryer set at 100° C. for 0.5 hours, additionally dried under vacuum at 120° C. for 4 hours, and roll-pressed to manufacture a positive electrode.

### Electrode Assembly Jelly Roll:

Each separator obtained in the reference examples and comparative reference examples was interposed between the manufactured positive electrode and negative electrode, and then wound to manufacture an electrode assembly jelly roll. The jelly roll was inserted into a pouch, an electrolyte was injected, and the pouch was vacuum-sealed. As the electrolyte, an electrolyte made by dissolving 1.3M LiPF₆ in a mixed solvent of ethylene carbonate (EC), ethyl methyl carbonate (EMC), and diethyl carbonate (DEC) in a volume ratio of 3:5:2 (based on a total of 10) was used. The jelly roll inserted in the pouch was pressed at 80° C. for 3 minutes while applying a pressure of 11.7 kgf/cm², thereby manufacturing a rechargeable lithium battery.

### 200-Cycle Capacity Retention Rate (Units: %)

For a battery manufactured using each separator of the reference examples and comparative reference examples, a cycle in which constant current charging was performed at a 0.5 C rate at 25° C. and 45° C. until the voltage reached 4.2 V, and then cut off at a 0.025 C rate in a constant voltage mode, and then the battery was discharged at a 0.5 C rate until 2.5 V was reached was repeated 200 times. A capacity retention rate according to the number of cycles, that is, lifespan characteristics, was evaluated, and results thereof were obtained.

Direct Current Internal Resistance (DC-IR, Units: mΩ)

The batteries with a cell capacity of 75 mAh manufactured using the separators of the reference examples and comparative reference examples were charged at 25° C. and 45° C. with constant current/constant voltage under 0.2 C, 4.25 V, and 0.05 C cut-off conditions, respectively, and after resting for 10 minutes, the batteries were discharged at a constant current under 0.33 C and 2.80 V cut-off conditions and allowed to rest for 10 minutes. After one charge-discharge cycle, the DC-IR was measured at SOC50 (state of charge 50%, which means the battery is charged to 50% of its total capacity (100%), or equivalently, discharged by 50%) by applying a current at 1 C for 10 seconds and measuring the resulting voltage drop (V).

A DC-IR change rate is the ratio of the DC-IR after 200 cycles to the initial DC-IR and is expressed as a percentage.

TABLE 2

| | | Reference Examples | | | | | | |
|---|---|---|---|---|---|---|---|---|
| | | 1 | 2 | 3 | 4 | 5 | 6 | 7 |
| | | Preparation | Preparation | Preparation | Preparation | Preparation | Preparation | Preparation |
| Binder | | Example 1 | Example 2 | Example 3 | Example 4 | Example 5 | Example 6 | Example 7 |
| Total | | 1.4 | 1.4 | 1.4 | 1.4 | 1.4 | 1.4 | 1.4 |
| thickness of | | | | | | | | |
| coating layer | | | | | | | | |
| 25° C. | Capacity | 85 | 88 | 91 | 92 | 90 | 89 | 76 |
| | retention | | | | | | | |
| | rate | | | | | | | |
| | Initial | 3.51 | 2.88 | 2.65 | 2.42 | 2.30 | 2.13 | 2.53 |
| | DC-IR | | | | | | | |
| | (mΩ) | | | | | | | |
| | DC-IR | 7.72 | 6.04 | 5.58 | 5.00 | 4.60 | 4.15 | 5.26 |
| | after | | | | | | | |
| | 200 | | | | | | | |
| | cycles | | | | | | | |
| | (mΩ) | | | | | | | |
| | DC-IR | 220 | 210 | 211 | 207 | 200 | 195 | 208 |
| | change | | | | | | | |
| | rate | | | | | | | |
| | after | | | | | | | |
| | 200 | | | | | | | |
| | cycles | | | | | | | |
| | (%) | | | | | | | |
| 45° C. | Capacity | 71 | 73 | 76 | 77 | 75 | 74 | 63 |
| | retention | | | | | | | |
| | rate | | | | | | | |
| | Initial | 3.19 | 2.61 | 2.40 | 2.20 | 2.09 | 1.93 | 2.30 |
| | DC-IR | | | | | | | |
| | (mΩ) | | | | | | | |
| | DC-IR | 10.52 | 8.23 | 7.61 | 6.82 | 6.27 | 5.66 | 7.18 |
| | after | | | | | | | |
| | 200 | | | | | | | |
| | cycles | | | | | | | |
| | (mΩ) | | | | | | | |
| | DC-IR | 330 | 315 | 317 | 311 | 300 | 293 | 312 |
| | change | | | | | | | |
| | rate | | | | | | | |
| | after | | | | | | | |
| | 200 | | | | | | | |
| | cycles | | | | | | | |
| | (%) | | | | | | | |

TABLE 3

| | | Comparative Reference Examples | | | | | |
|---|---|---|---|---|---|---|---|
| | | 1 | 2 | 3 | 4 | 5 | 6 |
| | | Comparative | Comparative | Comparative | Comparative | Comparative | Comparative |
| | | Preparation | Preparation | Preparation | Preparation | Preparation | Preparation |
| Binder | | Example 1 | Example 2 | Example 3 | Example 4 | Example 5 | Example 6 |
| Total | | 1.4 | 1.4 | 1.4 | 1.4 | 1.4 | 1.4 |
| thickness of | | | | | | | |
| coating layer | | | | | | | |
| 25° C. | Capacity | 80 | 70 | 45 | 50 | 89 | 40 |
| | retention | | | | | | |
| | rate | | | | | | |
| | Initial | 1.96 | 4.66 | 8.63 | 16.10 | 5.06 | 18.40 |
| | DC-IR | | | | | | |
| | (mΩ) | | | | | | |
| | DC-IR | 3.95 | 14.11 | 34.50 | 80.50 | 15.18 | 82.80 |
| | after | | | | | | |
| | 200 | | | | | | |
| | cycles | | | | | | |
| | (mΩ) | | | | | | |
| | DC-IR | 202 | 303 | 400 | 500 | 300 | 450 |
| | change | | | | | | |
| | rate | | | | | | |
| | after | | | | | | |
| | 200 | | | | | | |
| | cycles | | | | | | |
| | (%) | | | | | | |
| 45° C. | Capacity | 67 | 58 | 38 | 42 | 74 | 33 |
| | retention | | | | | | |
| | rate | | | | | | |
| | Initial | 1.78 | 4.23 | 7.84 | 14.64 | 4.60 | 16.73 |
| | direct | | | | | | |
| | DC-IR | | | | | | |
| | (mΩ) | | | | | | |
| | DC-IR | 5.39 | 19.24 | 47.05 | 109.77 | 20.70 | 112.91 |
| | after | | | | | | |
| | 200 | | | | | | |
| | cycles | | | | | | |
| | (mΩ) | | | | | | |
| | DC-IR | 303 | 455 | 600 | 750 | 450 | 675 |
| | change | | | | | | |
| | rate | | | | | | |
| | after | | | | | | |
| | 200 | | | | | | |
| | cycles | | | | | | |
| | (%) | | | | | | |

As shown in Table 2, it can be seen that the separators of the reference examples were capable of exhibiting high capacity retention rates at room temperature and high temperature and low DC-IR change rates after 200 cycles at room temperature and high temperature by including the above-described binder of the present disclosure.

On the other hand, as shown in Table 3, it can be seen that the separators of the comparative reference examples exhibited a relatively low capacity retention rate or a high DC-IR change rate by not including the above-described binder of the present disclosure.

### Example 1

The binder of Preparation Example 7 and boehmite (particle size D50: 50 nm, amorphous, pH: 7.71, BET specific surface area: 90.4 m²/g) as a filler were mixed in a binder: filler mass ratio of 1:20 based on solid content, and the mixture was added to a water solvent, and milled and dispersed at 25° C. for 30 minutes using a beads mill to prepare a dispersion for a first coating layer.

The binder of Preparation Example 7 and boehmite (particle size D50: 150 nm, cubic, pH: 7.22, BET specific surface area: 22.1 m²/g) as a filler were mixed in a binder: filler mass ratio of 1:20 based on solid content, and the mixture was added to a water solvent, and milled and dispersed at 25° C. for 30 minutes using a beads mill to prepare a dispersion for a second coating layer.

The dispersion for a first coating layer was applied onto one surface of a polyethylene-based film (commercially available from CZMZ, thickness: 5.5 μm, air permeability: 110 sec/100 cc, puncture strength: 360 kgf) as a porous substrate by a die coating method, the dispersion for a second coating layer was applied onto the other surface of the film by a die coating method, and the dispersions were dried under an absolute water vapor content (average value) of 14 g/m³ to form a first coating layer (thickness: 1 μm) and a second coating layer (thickness: 1 μm), thereby manufacturing a separator for a rechargeable lithium battery.

### Example 2

A separator was manufactured in the same manner as in Example 1, with a difference that the binder of Preparation Example 3 was used instead of the binder of Preparation Example 7.

### Example 3

A separator was manufactured in the same manner as in Example 1, with a difference that the binder of Preparation Example 6 was used instead of the binder of Preparation Example 7.

### Example 4

A separator was manufactured in the same manner as in Example 2, with a difference that each of the particle size D50 of the boehmite in the first coating layer and the second coating layer was changed as shown in the Table 4.

### Comparative Example 1

A separator was manufactured in the same manner as in Example 2, with a difference that a filler was not included in the first coating layer and second coating layer.

### Comparative Example 2

A separator was manufactured in the same manner as in Example 2, with a difference that a filler was not included in the second coating layer.

### Comparative Example 3

A separator was manufactured in the same manner as in Example 2, with a difference that boehmite (particle size D50: 150 nm, cubic, pH: 7.22, BET specific surface area: 22.1 m²/g) was included as a filler in the first coating layer, and a filler was not included in the second coating layer.

### Comparative Example 4

A separator was manufactured in the same manner as in Example 2, with a difference that boehmite (particle size D50: 150 nm, cubic, pH: 7.22, BET specific surface area: 22.1 m²/g) was included as a filler in the first coating layer and second coating layer.

### Comparative Example 5

A separator was manufactured in the same manner as in Example 2, with a difference that boehmite (particle size D50: 50 nm, amorphous, pH: 7.71, BET specific surface area: 90.4 m²/g) was included as a filler in the first coating layer and second coating layer.

Batteries were manufactured using the manufactured separator in the same manner as described above.

Air Permeability (Units: sec/100 cc)

The air permeability of the manufactured separator was determined by measuring the time (sec) taken for 100 cc of air to pass through the separator using a measuring device (EG01-55-1MR commercially available from ASAHI SEIKO Co. Ltd.).

Air permeability measurement device settings:

Measurement pressure: 0.5 kg/cm², cylinder pressure: 2.5 kg/cm², and set time: 10 seconds

### Electrolyte Wettability (Units: wt %)

The prepared binder was dried in an oven set at 120° C. for 12 hours to obtain a film (thickness: 20 μm, the weight (W1) before impregnation was measured). The film was placed in the manufactured pouch and impregnated with the electrolyte, and the pouch was vacuum-sealed. After the sealed pouch was allowed to stand in an oven set at 60° C. for 72 hours, the film was immediately taken out and weighed to obtain the weight (W2). Wettability was calculated by W2/W1×100.

### Positive Electrode Adhesion (Units: N)

The separator was attached to a positive electrode (manufactured in the same manner as in “Manufacture of battery”) and then inserted into a pouch, an electrolyte (1.3M LiPF₆ dissolved in a mixed solvent of EC, EMC, and DEC in a volume ratio of 3:5:2) was injected, and the resulting assembly was allowed to stand for 12 hours, pressed under conditions of a pressure of 10 kgf/cm² to 20 kgf/cm² and a temperature of 70° C. to 90° C. for 5 to 20 seconds, and disassembled. The separator and the positive electrode were taken out of the pouch, the positive electrode and the separator were spread out 180°, and the force required to detach the positive electrode from the separator was measured using a tensile tester (HT400 commercially available from Tinius Olsen).

Membrane Resistance Upon Impregnation with Electrolyte (Units: (2)

Membrane resistance was evaluated by electrochemical impedance spectroscopy (EIS) resistance. Each separator manufactured in the examples and comparative examples was impregnated with an electrolyte made by dissolving 1.5M LiPF₆ in a mixed solvent of EC, EMC, and dimethyl carbonate (DMC) in a volume ratio of 3:5:2, fitted onto an aluminum foil electrode with a lead tab, and sealed in an aluminum pack to manufacture a test cell. The resistance (Ω) of the test cell was measured at 20° C. by an alternating current (AC) impedance method (measurement frequency: 100 kHz).

### Heat Resistance (Units: %)

Heat resistance was evaluated by a shrinkage rate in an electrolyte.

The separators for a rechargeable lithium battery according to the examples and comparative examples were cut to a size of 8 cm×8 cm to prepare samples. A 5 cm×5 cm square was drawn on the surface of each sample.

97 wt % of LiCoNiAl as a positive electrode active material, 1.5 wt % of carbon nanotubes as a conductive material, and 1.5 wt % of polyvinylidene fluoride were mixed, and water was added to prepare a positive electrode slurry. The prepared positive electrode slurry was applied onto aluminum foil, dried, and roll-pressed to manufacture a positive electrode.

97.4 wt % of a negative electrode active material, 1.0 wt % of carboxymethyl cellulose, 1.5 wt % of styrene-butadiene rubber, and 0.1 wt % of carbon nanotubes as a conductive material were mixed to prepare a negative electrode active material slurry. As the negative electrode active material, a silicon-based negative electrode active material was used. The prepared negative electrode slurry was applied onto copper foil, dried, and roll-pressed to manufacture a negative electrode.

One sheet of the sample was interposed between the positive electrode and the negative electrode to prepare three sets of positive electrode-sample-negative electrode laminates, and the laminate was inserted into a pouch. 2 g of an electrolyte (1.5M LiPF₆ dissolved in a mixed solvent of EC, EMC, and DMC in a volume ratio of 30:50:20) was injected so that the laminate was completely saturated with the electrolyte, and the pouch was sealed and allowed to stand at 25° C. for 12 hours. Then, the resulting laminate was allowed to stand in an oven at 150° C. for 1 hour, the sample was taken out, and the dimensions of the sides of the drawn square were measured to calculate shrinkage rates in the machine direction (MD) and the transverse direction (TD). The shrinkage rate was calculated by the following Equation 1. MD and TD shrinkage rates were measured, and an average value thereof was obtained.

$$Shrinkage rate = ( L 0 - L 1 ) / L 0 \times 100. \qquad Equation 1$$

L0 is the initial length of the separator, L¹ is the length of the separator after being allowed to stand at 150° C. for 1 hour.

TABLE 4

| | | | | | | Filler | | | | | | |
|---|---|---|---|---|---|---|---|---|---|---|---|---|
| | | | | | | D50 | | | | Electrode | | |
| | | Copolymer | | | | First | Second | Air | Electrolyte | plate | | Heat |
| | Thickness* | SM | MMA | EHA | AMPS | layer | layer | permeability | wettability | adhesion | Resistance | resistance |
| Example 1 | 1/1 | 20 | 0 | 30 | 50 | 50 | 150 | 143 | 220 | 1.2 | 0.7 | 4.2 |
| Example 2 | 1/1 | 23 | 23 | 24 | 30 | 50 | 150 | 145 | 210 | 1.13 | 0.46 | 4.5 |
| Example 3 | 1/1 | 5 | 5 | 30 | 60 | 50 | 150 | 142 | 140 | 0.9 | 0.37 | 4.3 |
| Example 4 | 1/1 | 23 | 23 | 24 | 30 | 50 | 300 | 138 | 220 | 1.1 | 0.34 | 4.8 |
| Comparative | 1/1 | 23 | 23 | 24 | 30 | — | — | 250 | 130 | 2.13 | 0.3 | 50 |
| Example 1 | | | | | | | | | | | | |
| Comparative | 1/1 | 23 | 23 | 24 | 30 | 50 | — | 200 | 150 | 1.8 | 0.38 | 10.2 |
| Example 2 | | | | | | | | | | | | |
| Comparative | 1/1 | 23 | 23 | 24 | 30 | 150 | — | 170 | 170 | 1.53 | 0.46 | 20.5 |
| Example 3 | | | | | | | | | | | | |
| Comparative | 1/1 | 23 | 23 | 24 | 30 | 150 | 150 | 125 | 300 | 1.13 | 0.46 | 10.2 |
| Example 4 | | | | | | | | | | | | |
| Comparative | 1/1 | 23 | 23 | 24 | 30 | 50 | 50 | 150 | 232 | 0.82 | 1.44 | 4.6 |
| Example 5 | | | | | | | | | | | | |

*In Table 4, thickness is the thickness of first coating layer/the thickness of second coating layer.

As shown in Table 4, the separators of the examples were capable of exhibiting high electrolyte wettability, desired or improved air permeability, and high adhesion to an electrode plate.

The separator for a rechargeable lithium battery according to an example embodiment can improve the capacity of the rechargeable lithium battery, and can also improve the safety and lifespan of the rechargeable lithium battery.

Example embodiments of the present disclosure have been described, but the present disclosure is not limited thereto. Various modifications may be carried out within the scope of the claims, the detailed description of the present disclosure, and the appended drawings, and are also included in the scope of the present disclosure.

What is claimed is:

1. A separator for a rechargeable lithium battery, the separator comprising:
a porous substrate;
a first coating layer on a first surface of the porous substrate; and
a second coating layer on a second surface of the porous substrate,
wherein the first coating layer includes a first binder and a first filler, and the second coating layer includes a second binder and a second filler,
the first binder and the second binder each include a copolymer including a first structural unit including a unit derived from an aromatic based unsaturated monomer; a second structural unit derived from a (meth)acrylic monomer containing an alkyl group having 4 or more carbon atoms in the main chain in the ester moiety;
and a third structural unit derived from a sulfonic acid group-containing monomer, with respect to 100 mol % of the copolymer, about 5 mol % to about 80 mol % of the first structural unit, about 10 mol % to about 40 mol % of the second structural unit, and about 5 mol % to about 80 mol % of the third structural unit are included,
and
the first filler and the second filler satisfy the following Expression 1:
$$( Average particle size ( D 50 ) of second filler ) / ( Average particle size ( D 50 ) of first filler ) \geq 3. \qquad Expression 1$$

2. The separator of claim 1, wherein the first filler has an average particle size D50 of more than 0 nm and less than about 100 nm, and the second filler has an average particle size D50 of about 100 nm or more and about 300 nm or less.

3. The separator of claim 1, wherein the first filler is amorphous, and the second filler is cubic.

4. The separator of claim 1, wherein the first filler and the second filler have a pH of about 7 or higher.

5. The separator of claim 1, wherein the first filler and the second filler each comprise at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof.

6. The separator of claim 1, wherein the first binder and the second binder each have a glass transition temperature in a range of about 60° C. to about 80° C.

7. The separator of claim 1, wherein the first binder and the first filler are included in a mass ratio in a range of about 1:10 to about 1:50, and the second binder and the second filler are included in a mass ratio in a range of about 1:10 to about 1:50.

8. The separator of claim 1, wherein the unit derived from the aromatic based unsaturated monomer is represented by Chemical Formula 1 below: 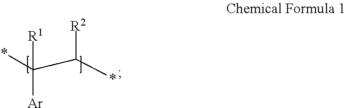
in Chemical Formula 1,
R¹ and R² each independently comprises hydrogen or a substituted or unsubstituted C1 to C5 alkyl group, and
Ar comprises a substituted or unsubstituted, monocyclic or polycyclic C6 to C20 aryl group,
the second structural unit is represented by Chemical Formula 4 below: 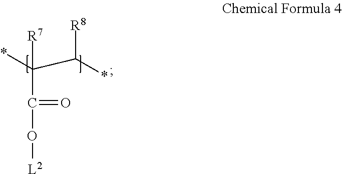
in Chemical Formula 4,
R⁷ and R⁸ each independently comprises hydrogen or a methyl group, and
L² comprises a substituted or unsubstituted, straight or branched C4 to C30 alkyl group, and
the third structural unit is represented by any one of Chemical Formulas 5 to 7 below: 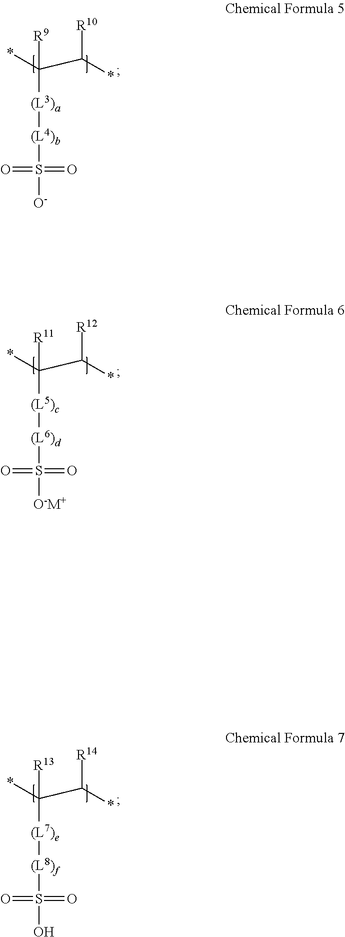
in Chemical Formulas 5 to 7,
R⁹, R¹⁰, R¹¹, R¹², R¹³, and R¹⁴ each independently comprises hydrogen or a C1 to C3 alkyl group,
L³, L⁵, and L⁷ each independently comprises —C(═O)—, —C(═O)O—, —OC(═O)—, —O—, or —C(═O)NH—,
L⁴, L⁶, and L⁸ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
a, b, c, d, e, and f are each independently an integer in a range from 0 to 2, and
in Chemical Formula 6,
M comprises an alkali metal.

9. The separator of claim 1, wherein the first structural unit further comprises a unit derived from a (meth)acrylic monomer containing an alkyl group having 1 to 3 carbon atoms in the main chain in the ester moiety.

10. The separator of claim 9, wherein the unit derived from the (meth)acrylic monomer is represented by the following Chemical Formula 3: 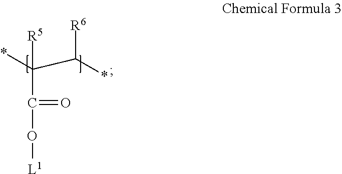
in Chemical Formula 3,
R⁵ and R⁶ each independently comprises hydrogen or a methyl group, and
L¹ comprises a substituted or unsubstituted, straight or branched C1 to C3 alkyl group.

11. The separator of claim 9, wherein the unit derived from the aromatic based unsaturated monomer and the unit derived from the (meth)acrylic monomer are included in a molar ratio in a range of about 1:0.5 to about 1:2.

12. The separator of claim 9, wherein with respect to 100 mol % of the copolymer, about 5 mol % to about 35 mol % of the structural unit derived from the aromatic based unsaturated monomer, about 5 mol % to about 35 mol % of the structural unit derived from the (meth)acrylic monomer containing an alkyl group having 1 to 3 carbon atoms in the main chain in the ester moiety, about 20 mol % to about 30 mol % of the second structural unit, and about 10 mol % to about 60 mol % of the third structural unit, are included.

13. The separator of claim 9, wherein the copolymer comprises:
a structural unit derived from an aromatic based unsaturated monomer derived from one or more of styrene, α-methyl styrene, 4-butyl styrene, 4-butoxy styrene, halo styrene, vinyl toluene, and vinyl naphthalene;
a structural unit derived from a (meth)acrylic monomer containing an alkyl group having 1 to 3 carbon atoms in the main chain in the ester moiety, which is derived from one or more of methyl (meth)acrylate, ethyl (meth)acrylate, n-propyl (meth)acrylate, and iso-propyl (meth)acrylate;
a second structural unit derived from one or more of 2-ethylhexyl (meth)acrylate, n-butyl (meth)acrylate, iso-butyl (meth)acrylate, tert-butyl (meth)acrylate, pentyl (meth)acrylate, hexyl (meth)acrylate, heptyl (meth)acrylate, n-octyl (meth)acrylate, nonyl (meth)acrylate, isononyl (meth)acrylate, decyl (meth)acrylate, and isodecyl (meth)acrylate; and
a third structural unit derived from at least one of vinyl sulfonic acid, allyl sulfonic acid, styrene sulfonic acid, anethol sulfonic acid, (meth)acrylamido alkane sulfonic acid, sulfoalkyl (meth)acrylate, and a salt thereof.

14. The separator of claim 1, wherein the first coating layer and the second coating layer each have a thickness in a range of about 0.1 μm to about 1.5 μm.

15. A rechargeable lithium battery comprising:
a positive electrode;
a negative electrode; and
the separator according to claim 1 interposed between the positive electrode and the negative electrode.
